(19) United States
(12) Patent Application Publication
(10) Pub. No.: US 2015/0340688 A1
(43) Pub. Date: Nov. 26, 2015

(54) METHOD FOR PREPARING SULFUR-CARBON COMPOSITE BY DUAL DRY COMPLEXATION

(71) Applicant: Hyundai Motor Company, Seoul (KR)

(72) Inventors: Jun Ki Rhee, Suwon (KR); Sam Ick Son, Uiwang (KR); Ju Young Sung, Uiwang (KR)

(21) Appl. No.: 14/569,672

(22) Filed: Dec. 13, 2014

(30) Foreign Application Priority Data
May 26, 2014 (KR) 10-2014-0063227

(51) Int. Cl. H01M 4/36; H01M 4/136; H01M 4/04; H01M 4/133; H01M 4/62; H01M 4/38

(52) U.S. Cl. CPC H01M 4/366; H01M 4/625; H01M 4/38; H01M 4/0421; H01M 4/133; H01M 4/136

(57) ABSTRACT

Disclosed are a sulfur-carbon composite and a method of preparing the sulfur-carbon composite by dual dry complexation. The sulfur-carbon composite has a structure that fibrous carbon is introduced to an interior of sulfur and carbon is coated to an exterior of the sulfur.

### CROSS-REFERENCE TO RELATED APPLICATION

This application claims under 35 U.S.C. §119(a) the benefit of Korean Patent Application No. 10-2014-0063227 filed on May 26, 2014, the entire contents of which are incorporated herein by reference.

### TECHNICAL FIELD

The present invention relates to a method of preparing a sulfur-carbon composite for improving conductivity of a sulfur active material. In particular, the method for maximizing improvement of conductivity of a sulfur particle composite material by complexing carbon materials in an interior and on an exterior of the sulfur particle composite material.

### BACKGROUND

Lithium-sulfur batteries have been developed as a next generation battery due to high capacity thereof. In the lithium-sulfur batteries, sulfur is an active material of a positive electrode and is a necessary material for providing capacity, but sulfur is a non-conducting material which does not conduct an electric current. Accordingly, sulfur may be a resistant element to electron transfer in the positive electrode.

In the related art, when a conventional positive electrode of a lithium-sulfur battery is manufactured, sulfur, carbon, and a binder are mixed and a mortar, a mixer, a ball mill and the like are often used for the mixture. In particular, homogeneous mixing may be necessary to provide an electron conduction path in an electrode and battery reaction site. Accordingly, since the sulfur is an electrically non-conduction material, it may be mixed with a carbon material as a conducting material.

In another related art, a technique for preparing a sulfur-carbon composite has been developed. However, in such a technique, resistance may not be reduced sufficiently and conductivity may not be improved when the composite is prepared by adhering carbon to surface of sulfur.

Further, in the related art, an active material of a positive electrode in a metal-sulfur battery has been introduced. The active material includes a sulfur-carbon composite, which is prepared by complexing a globular sulfur compound particle with a carbon material particle. The composite may be prepared by fixing a dispersed spherical carbon material or fibrous carbon material as being coated on the surface of the sulfur compound particle, or by fixing mixed spherical carbon material and the fibrous carbon material as being fixed on an exterior surface and an interior of the sulfur compound particle.

Moreover, a method for manufacturing a carbon-sulfur composite has been developed and the method includes: preparing a hard carbon ball; mixing the hard carbon ball and sulfur; depositing the sulfur inside of the hard carbon ball by heating the mixture of the hard carbon ball and the sulfur at a first temperature; cooling the hard carbon ball where the sulfur is deposited inside thereof to a room temperature; and heating the hard carbon ball where the sulfur is deposited inside thereof at a second temperature under a predetermined pressure. In other example, an active material of a positive electrode for a lithium secondary battery manufactured from lithium-transition metal oxide has been developed. For the active material, a composite of oxygen (O) or sulfur (S) compound and a carbon-based particle (‘compound-carbon composite’) are coated on the surface of the lithium-transition metal oxide, and the compound-carbon composite is chemically combined to the surface of the lithium-transition metal oxide.

Further, in the related art, a lithium sulfide-carbon composite formed by joining lithium sulfide and a carbon material has been developed. The carbon material includes carbon content in an amount of 15 to 70 wt %, tap density thereof is about 0.4 g/cm³ or greater when the carbon content is 30 wt % or greater, and tap density is 0.5 g/cm³ or greater when the carbon content is less than 30 wt %.

In the conventional techniques, the carbon may be typically attached using a separate binder. Accordingly, resistance may not be reduced sufficiently, and the content of the loaded sulfur as active material of the positive electrode is reduced due to addition of transition metal.

The above information disclosed in this section is merely for enhancement of understanding of the background of the invention and therefore it may contain information that does not form the prior art that is already known in this country to a person of ordinary skill in the art.

### SUMMARY

The present invention may provide technical solutions to the above-described technical difficulties in the related art.

In one aspect, the present invention provides a method for preparing a sulfur-carbon composite with improved conductivity of a sulfur active material for positive electrode of a lithium-sulfur battery. In particular, the method may improve conductivity substantially by complexing a carbon material to an interior and an exterior of a sulfur material. The sulfur material suitably may be for example a sulfur particle. In an exemplary embodiment, a method for preparing a sulfur-carbon composite using dual dry complexation is provided. As used herein, the sulfur-carbon composite may be an active material of a positive electrode in a lithium-sulfur secondary battery. The method may include : providing sulfur and fibrous carbon into a dry-type complexation device; applying shear force to the sulfur and the fibrous carbon to introduce the fibrous carbon into an interior of the sulfur, thereby forming a primary composite; providing carbon particle or additional fibrous carbon into the dry complexation device where the primary composite is formed; and coating an exterior of the sulfur where the carbon fiber is introduced with the carbon particle or the additional fibrous carbon, thereby forming the sulfur-carbon composite of the present invention.

The fibrous carbon may be a vapor deposited carbon fiber, a carbon nanotube or a mixture thereof, and the carbon particle suitably may be for example a Super C, Ketjen Black, Denka Black or a mixture thereof. When applying the shear force to the sulfur and the carbon fiber, a complexation energy may be of about 300 to 600 watt generated by spinning a blade of the dry complexation device. Further, when coating the exterior of the sulfur, a complexation energy thereof may be of about 300 to 600 watt generated by spinning a blade of the dry complexation device. The spinning in the application of the shear force may be conducted for about 15 min to 25 min.

In addition, the sulfur may be provided in an amount of about 85 to 95 wt % and the fibrous carbon may be provided in an amount of 5 to 15 wt %, based on the total weight of the material provided in the complexation device.. In the coating process, the spinning may be conducted for about 10 min. In addition, the primary composite from the process of applying the shear force may be provided in an amount of about 85 to 95 wt % and the carbon particle or the additional carbon fiber may be provided in an amount of about 5 to 15 wt %, based on the total weight of the material provided in the complexation device.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 shows an exemplary dual dry complexed sulfur-carbon composite according to an exemplary embodiment of the present invention;

FIG. 2 shows a conventional dry-type complexation in the related arts;

FIG. 3 shows scanning electron microscopic (SEM) views of exemplary composites during dry-type complexation depending on time according to an exemplary embodiment of the present invention;

FIG. 4 shows an exemplary method of conducting the dry-type complexation according to an exemplary embodiment of the present invention;

FIG. 5 shows an exemplary thermal analysis graph of an exemplary composite obtained after introducing carbon fiber into the interior of the sulfur as the primary composite during the dual dry complexation according to an exemplary embodiment of the present invention; and

FIG. 6 shows an exemplary discharge graph including an exemplary coin cell which uses an exemplary sulfur-carbon composite prepared by an exemplary dual dry complexation method according to an exemplary embodiment of the present invention; and a conventional coin cell which uses conventional sulfur as a positive active material, respectively.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

An exemplary cross-sectional view of an exemplary sulfur-carbon composite prepared by an exemplary method of dual dry complexation in the present invention is shown in FIG. 1. The composite may have fibrous carbon introduced into the interior of the sulfur and carbon particles coated to the exterior surface of the sulfur.

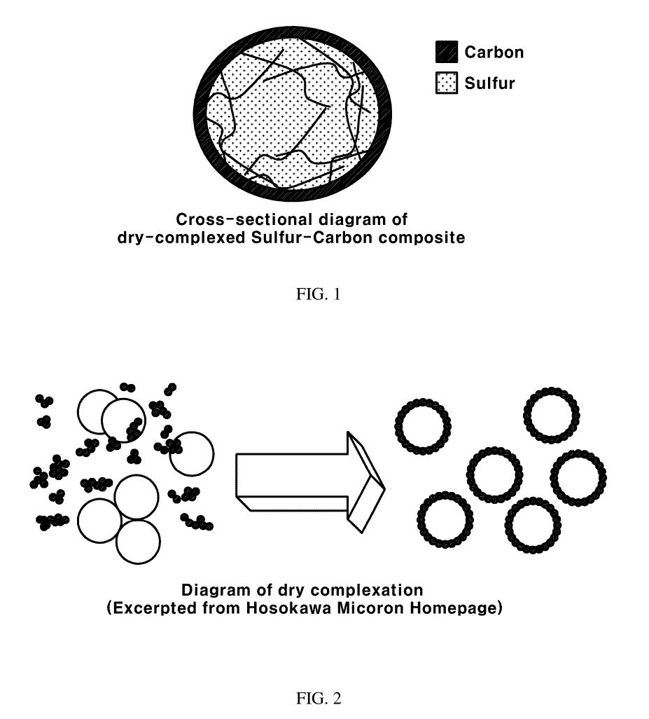

Dry-type complexation may be conducted using a dry-type complexation device which may prepare solid materials by mechanical force without a binder (FIG. 2). It is also appreciated that NOB-MINI manufactured from Hosokawa Micron may provide a suitable option as the type-complexation device. An exemplary dry-type complexation method of preparing the composite may include: providing materials for complexation into a tightly sealed container; rotating a blade having a minimal gap to a side wall of the container at substantially high speed. As a result, the materials for complexation may be formed by shear force generated in the container.

When the dry-type complexation method is used, a conduction path to non-conducting sulfur may be obtained to the maximum by placing carbon as a conductor to the interior or exterior of the sulfur. Particularly, the conduction path may also be formed inside of the sulfur by introducing fibrous carbon material to the interior of the sulfur. Further, according to an exemplary embodiment of the present invention, the dry-type complexation may be repeated, particularly twice.

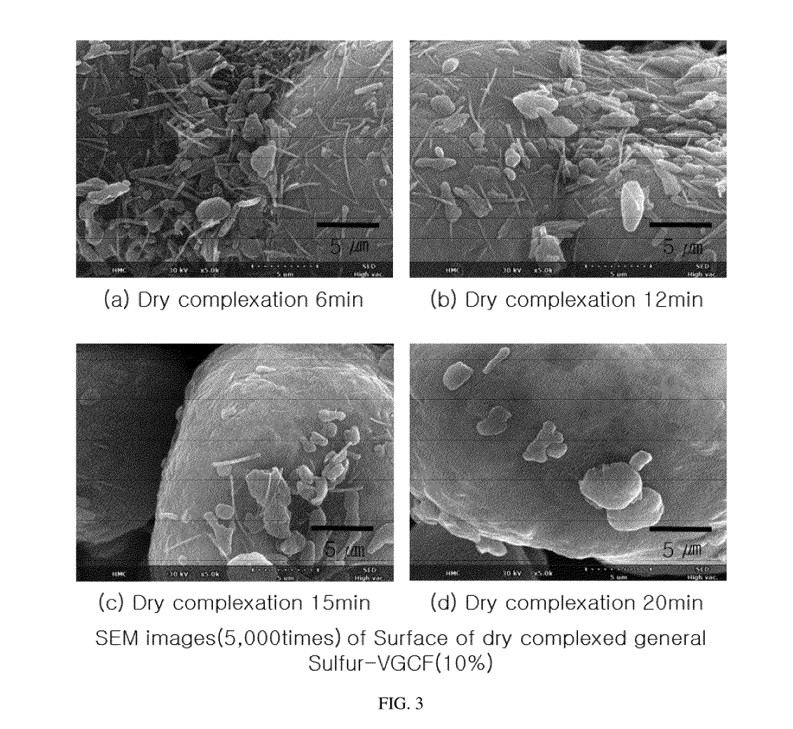

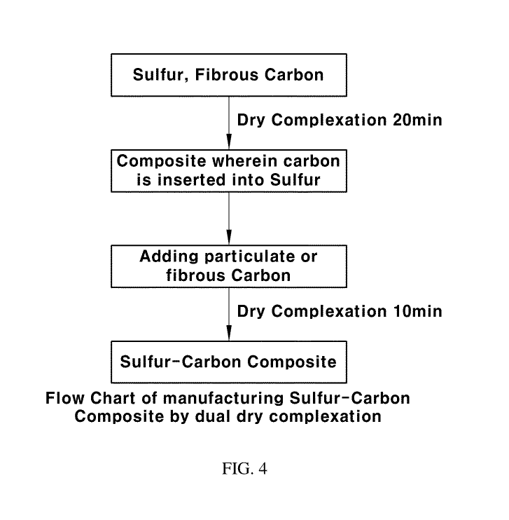

FIG. 3 shows SEM images of each result of introducing carbon into the sulfur from the dry-type complexation depending on time. When the dry-type complexation is conducted for greater than about 12 min, the carbon on the surface may begin to be introduced into the sulfur.

In particular, to obtain the conduction path to the inside, a fibrous carbon may be introduced. After conducting the dry-type complexation for about 15 min, the fibrous carbon may penetrate through the surface of the sulfur. After conducting the dry-type complexation for about 20 min, most of the carbon may be introduced to the interior of the sulfur.

The manufacturing method of the present invention including the dry-type complexation step will be described in detail.

In an exemplary embodiment, the method for preparing a sulfur-carbon composite using dual dry complexation may include: providing sulfur and fibrous carbon into a dry-type complexation device; applying shear force to the sulfur and the fibrous carbon to introduce the fibrous carbon into the sulfur, thereby forming a primary composite;; providing carbon particles or additional fibrous carbon into the dry complexation device where the primary composite is formed ; and coating an exterior of the sulfur where the carbon fiber is introduced with the carbon particle or the additional fibrous carbon, thereby forming the sulfur-carbon composite.

The sulfur-carbon composite may be used as an active material of a positive electrode of a lithium-sulfur secondary battery. The fibrous carbon may be, but not limited to, a vapor deposited carbon fiber, carbon nanotube or mixtures thereof, and the carbon particles may be, but not limited to, Super C, Ketjen Black, Denka Black or mixtures thereof.

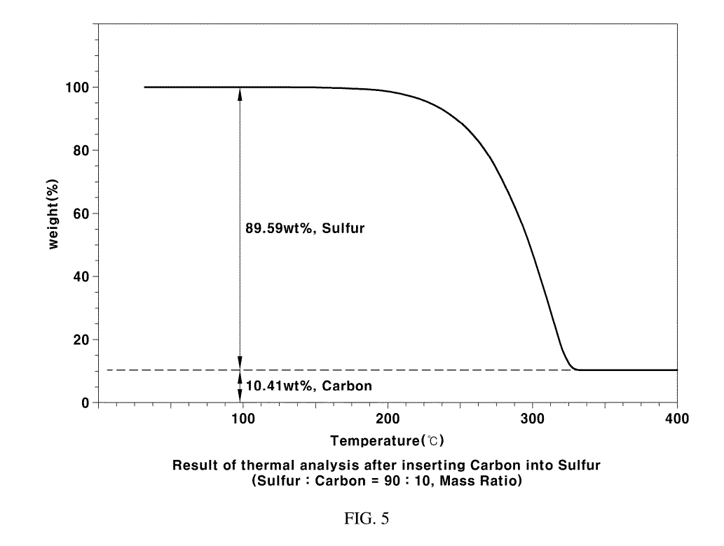

When the shear force is applied, a complexation energy may be in a range of about 300 to 600 watt, or particularly about 400 watt and the shear force may be applied by spinning a blade of the dry complexation device. In particular, the spinning may be conducted for about 15 min to 25 min, or particularly for about 20 min as shown in the SEM images of FIG. 3 to optimally introduce the fibrous carbon. As shown in FIG. 3, the fibrous carbon may be completely introduced into the sulfur after conducting the complexation for about 20 min. The materials to be complexed may be the sulfur in an amount of about 85 to 95 wt % and the fibrous carbon in an amount of about 5 to 15 wt % (FIG. 5).

The sulfur may be still used as an active material in a lithium-sulfur battery, and the carbon may be added for the conduction path, but the carbon may not be involved in the capacity development. Accordingly, the amount of the carbon may be minimally to maintain the conduction path. When using the composite of sulfur and the carbon within the ratio as described above, the carbon inside of the sulfur may maintain an optimized conduction path without losing capacity.

In addition, when the carbon particles or the fibrous carbon is coated, a complexation energy may be in a range of about 300 to 600 watt, or particularly about 400 watt and the coating may be conducted by spinning a blade of the dry complexation device. The spinning may be conducted for about 10 min, which may be particularly adjusted to make the fibrous carbon or carbon particle coat the exterior of the sulfur. The materials to be complexed in the step (d) or to be provided in the step (c) may be the primary composite obtained in the step (b) in an amount of about 85 to 95 wt % and the additional fibrous carbon or carbon particles in an amount of about 5 to 15 wt %, based on the total weight of the material provided in the dry-complexation device in step (c). As described above in the step (b), the amount of the carbon may be used in minimum as possible just to maintain conductivity. When using the sulfur and the carbon within the range as described above, the carbon outside of the sulfur may maintain an optimized conduction path.

In the step (b) or (d), the sulfur and the carbon may be provided in an amount of 60 vol % or greater, based on the internal volume of the dry-type complexation container.

### EXAMPLES

The following examples illustrate the invention and are not intended to limit the same. EXAMPLE

Sulfur in an amount of about 90 wt % and vapor deposited carbon fiber in an amount of about 10 wt % based on the total weight of the material were provided into a dry complexation device in an amount of about 60 vol % or greater, based on the internal volume thereof. The sulfur and the carbon fiber were complexed for about 20 min at the complexation energy of about 400 watt to form a primary composite. Super C in an amount of about 10 wt % was further added to the primary composite in an amount of about 90 wt % based on the total weight of the material in the dry-complexation device and the total volume thereof was about 60 vol % or greater based on the internal volume of the dry complexation device. Then, the primary composite and the added carbon were secondarily complexed at the complexation energy of about 400 watt for about 10 min to prepare a dual dry complexed sulfur-carbon composite of the present invention.

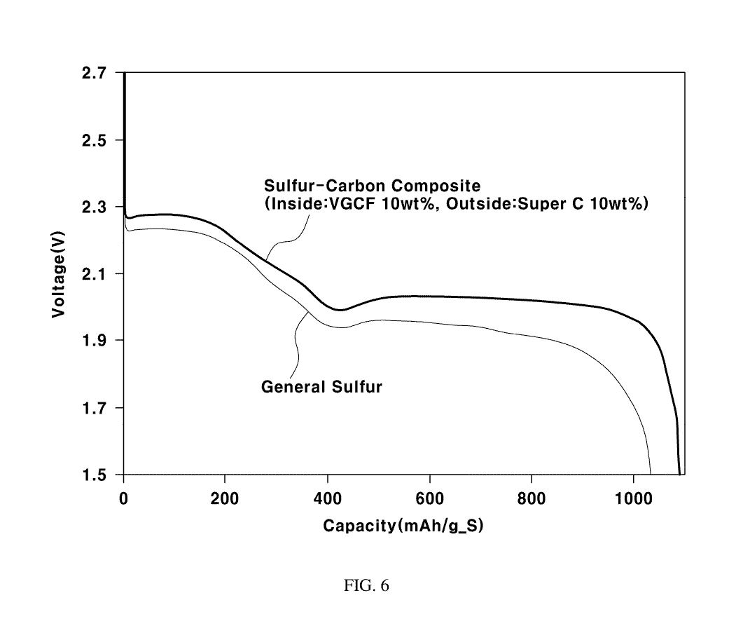

Each coin cell was manufactured by using the prepared composite in Example or general sulfur in Comparative Example as an active material of a positive electrode in a lithium-sulfur secondary battery, respectively, and then discharge voltage and discharge capacity were measured (FIG. 6). As shown in FIG. 6, Example had greater voltage and greater discharge capacity than Comparative Example. Accordingly, resistance in the electrode may be reduced and the quality of the electrode may be improved by the sulfur-carbon composite of the present invention.

According to various exemplary embodiments of the present invention, capacity of a lithium-sulfur battery may increase with advantageous effects. For example, conduction path may be maximized in the sulfur active material, thereby reducing electric resistance inside of the positive electrode substantially. In addition, since sulfur and carbon are homogeneously dispersed before use, electrode active materials may be dispersed homogeneously, and thus a homogeneously dispersed electrode may be be obtained. As consequence, quality of the electrode may be improved and battery reaction may occur stably. Moreover, the content of sulfur used as active material may increase because of the reduced use of binder due to improved dispersion. Accordingly, the amount of active material used may increase, thereby battery capacity may increase.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A method for preparing a sulfur-carbon composite using dual dry complexation, comprising steps of
(a) providing sulfur and fibrous carbon into a dry complexation device;
(b) applying shear force to the sulfur and the fibrous carbon to introduce the fibrous carbon into the sulfur, thereby forming a primary composite;
(c) providing carbon particle or additional fibrous carbon into the dry complexation device where the primary composite is formed; and
(d) coating an exterior of the primary composite with the carbon particle or additional fibrous carbon, thereby forming the sulfur-carbon composite.

2. The method of claim 1, wherein the sulfur-carbon composite is an active material of a positive electrode in a lithium-sulfur secondary battery.

3. The method of claim 1, wherein in the step (b), a complexation energy is of about 300 to 600 watt by spinning a blade of the dry complexation device.

4. The method of claim 1, wherein in the step (d), a complexation energy is of about 300 to 600 watt by spinning the blade of the dry complexation device.

5. The method of claim 1, the fibrous carbon is a vapor deposited carbon fiber, a carbon nanotube or mixtures thereof.

6. The method of claim 1, the carbon particle is Super C, Ketjen Black, Denka Black or mixtures thereof.

7. The method of claim 3, wherein the spinning of the step (b) is conducted for about 15 min to 25 min.

8. The method of claim 1, wherein in the step (a), in the dry complexation device, the sulfur is provided in an amount of about 85 to 95 wt % and the fibrous carbon is provide in an amount of about 5 to 15 wt %, based on the total weight of the material in the complexation device in the step (a).

9. The method of claim 4, wherein the spinning of the step (d) is conducted for about 10 min.

10. The method of claim 1, wherein in the step (c), in the dry complexation device, the primary composite from the step (b) is provided in an amount of about 85 to 95 wt % and the carbon particle or the additional fibrous carbon is provided in an amount of 5 to 15 wt %, based on the total weight of the material in the complexation device in the step (c).

11. A lithium-sulfur battery comprising the sulfur-carbon composite prepared by claim 1 as an active material of a positive electrode.
